(19) United States
(12) Patent Application Publication
(10) Pub. No.: US 2002/0058530 A1
(43) Pub. Date: May 16, 2002

(54) Hand-held terminal and server for multimedia communication

(76) Inventor: Katsuaki Akama, Yokohama (JP)

Correspondence Address: ROSENMAN & COLIN LLP, 575 MADISON AVENUE, NEW YORK, NY, 10022-2585, US

(21) Appl. No.: 09/910,963

(22) Filed: Jul. 23, 2001

(30) Foreign Application Priority Data
Nov. 10, 2000 (JP) 2000-343467

(51) Int. Cl. H04M 1/00

(52) U.S. Cl. 455/556; 455/557

(57) ABSTRACT

A hand-held terminal such as the hand-held information terminal (PDA) (1-1) and hand-held telephone set (1-2) used in the IMT-2000 mobile system or the like and the multimedia home server system (1-3) are incorporated, the functions of the multiple function telephone terminal (1-31), printer (1-32), video communication apparatus (1-33), personal computer (1-34) or the like in the multimedia home server system (1-3) are plugged in as required dynamically to the hand-held terminal via the multimedia home server (1-35), and the hand-held terminal utilizes each multimedia communication service offered in the IMT2000 mobile system using the multimedia communication apparatus plugged in.

### BACKGROUND OF THE INVENTION

### FIELD OF THE INVENTION

The present invention relates to a hand-held terminal and a server for multimedia communication to perform dynamic negotiation and particularly to a hand-held terminal and a server for multimedia communication that enable use, through the dynamic negotiation, of the function of various multimedia communication services offered by the IMT-2000 (International Mobile Telecommunications 2000) mobile system or the like that is the mobile communication system specified with ITU (International Telecommunication Union).

With multimedia communication in the IMT2000 mobile system, communication is possible only among the multimedia communication apparatuses of the same kind and different communication apparatuses must be used corresponding to the communication services. Therefore, in the case of text message communication, communication can be realized by using a communication terminal for text message communication of the same kind as the communication partner as illustrated in FIG. 28(A) and in the case of video communication, communication can be realized by using a communication terminal having the function for video communication of the same kind as the communication partner as illustrated in FIG. 28(B).

But with diversification in the kind of multimedia communication services, when it is requested to utilize various kinds of multimedia communication services in the mobile environment, a communication terminal must be carried depending on the kind of respective multimedia communication. For example, as illustrated in FIG. 29, when it is requested to utilize many multimedia communication services offered in the IMT2000 mobile system, many communication terminals individually mounting these communication service functions must be carried.

Namely, as illustrated in FIG. 29, a user of the IMT2000 mobile system or the like is requested to carry a hand-held information terminal (PDA: Personal Digital Assistants) 29-1, a multiple function telephone terminal 29-2, a personal computer 29-3, a video communication apparatus 29-4 and a printer 29-5 or the like, but it is difficult to actually carry these apparatuses and therefore a user can utilize only a part of the services such as only audio communication or the like among the many multimedia communication services of the IMT2000 mobile system available.

When it is attempted to form a hand-held terminal for multimedia communication mounting complete multimedia communication services in view of offering all multimedia communication service of the IMT2000 mobile system for users moving from point to point, even little utilized communication service functions must also be mounted and therefore the hand-held terminal for multimedia communication unnecessarily becomes large in size and heavy in weight, resulting in a problem of portability.

Moreover, a hand-held terminal mounting various multimedia communication service functions becomes expensive and when each user of a family or organization such as a work place tries to utilize various multimedia communication service functions by carrying respective hand-held terminals, each member of the family and organization must purchase expensive hand-held terminals, although it is a large economical share.

Moreover, the multimedia communication service function loaded initially in the hand-held terminal has been often up-graded for individual media communication function or additionally given a new media communication function. Therefore, when it is requested to utilize the new performance and communication services of the new function, a user is requested to additionally buy the new hand-held terminal itself for new multimedia communication mounting the new performance and functions. It is also a large economical share.

An object of the present invention is to provide a hand-held terminal of a simplified structure that can utilize various multimedia communication services offered with the IMT2000 mobile system or the like using a small size hand-held terminal and can also utilize the necessary multimedia communication service functions when requested without mounting various multimedia communication service function to such a hand-held terminal and also provide a server to add, to such a hand-held terminal, the necessary multimedia communication service function with negotiation between the other multimedia communication apparatus and the hand-held terminal of the communication partner.

### SUMMARY OF THE INVENTION

A hand-held terminal for multimedia communication of the present invention has a unit for negotiating with a server controlling a multimedia communication apparatus for reserving a function of said multimedia communication apparatus and a unit for conducting multimedia communication with a communication apparatus of a communication partner through a negotiation with the communication apparatus of the communication partner in regard to the function that is allowed in use with the negotiation.

Moreover a server of the present invention has a unit for managing a multimedia communication apparatus, a unit for conducting the negotiation with the hand-held terminal for occupation (reservation) of a function of the multimedia communication apparatus and a unit for occupying (reserving) the function for the hand-held terminal.

### BRIEF DESCRIPTION OF THE DRAWINGS

FIG. 1 illustrates a diagram with respect to an example of apparatus used for hand-held terminals for multimedia communication of the present invention.

FIG. 2 illustrates a diagram with respect to a network connection structure of a hand-held terminal for multimedia communication and a server of the present invention.

FIG. 3 illustrates a diagram with respect to a function block of the private hand-held terminal of the present invention.

FIG. 4 illustrates a diagram with respect to a function block of the multimedia home server of the present invention.

FIG. 5 illustrates a diagram with respect to an example of an automatic connection of the hand-held terminal of the present invention to the multimedia home server by a local radio link.

FIG. 6 illustrates a diagram with respect to an example of a user authentication connection of the hand-held terminal of the present invention to the multimedia home server by the local radio link.

FIG. 7 illustrates a diagram with respect to an example of a charging system of the multimedia communication of the present invention.

FIG. 8 illustrates a diagram with respect to an example of a multimedia profile display image in the hand-held terminal of the present invention.

FIG. 9 illustrates a diagram with respect to the multimedia profile items.

FIG. 10 illustrates a diagram with respect to a display example of the multimedia profile display image displayed depending on the multimedia profile information of the user side of the hand-held terminal and communication partner.

FIG. 11 illustrates a diagram with respect to a manipulation example of multimedia communication with the hand-held terminal of the present invention.

FIG. 12 illustrates a diagram with respect to the dynamic service function adding negotiation procedure of the present invention.

FIG. 13 illustrates a diagram with respect to the communication line selection process procedure in the hand-held terminal of the present invention.

FIG. 14 illustrates a diagram with respect to the charge collection process and line selection procedure in the present invention.

FIG. 15 illustrates a diagram with respect to the security ensuring process procedure in the present invention.

FIG. 16 illustrates a diagram with respect to an example of the initial communication process procedure in the present invention.

FIG. 17 illustrates a diagram with respect to an example of the user authentication connection procedure in the present invention.

FIG. 18 illustrates a diagram with respect to an example of a local communication automatic connection procedure in the present invention.

FIG. 19 illustrates a diagram with respect to an example of multimedia communication disconnection procedure of user authentication connection in the present invention.

FIG. 20 illustrates a diagram with respect to an example of multimedia communication disconnection procedure of local communication automatic connection in the present invention.

FIG. 21 illustrates a diagram with respect to an example of the charge collection process procedure in the present invention.

FIG. 22 illustrates a diagram with respect to an example of the security ensuring process procedure in the present invention.

FIG. 23 illustrates a diagram with respect to an example of use of the hand-held terminal and server of the present invention in the user's house.

FIG. 24 illustrates a diagram with respect to an example of use of the hand-held terminal and server of the present invention in the office of a company or the like.

FIG. 25 illustrates a diagram with respect to an example of use of the hand-held terminal of the present invention in a public telephone set.

FIG. 26 illustrates a diagram with respect to an example of use of the hand-held terminal of the present invention in a convenience store.

FIG. 27 illustrates a diagram with respect to an example of use of the hand-held terminal of the present invention in a taxi.

FIG. 28 illustrates a diagram with respect to an example of a communication terminal used in the multimedia communication of the related art.

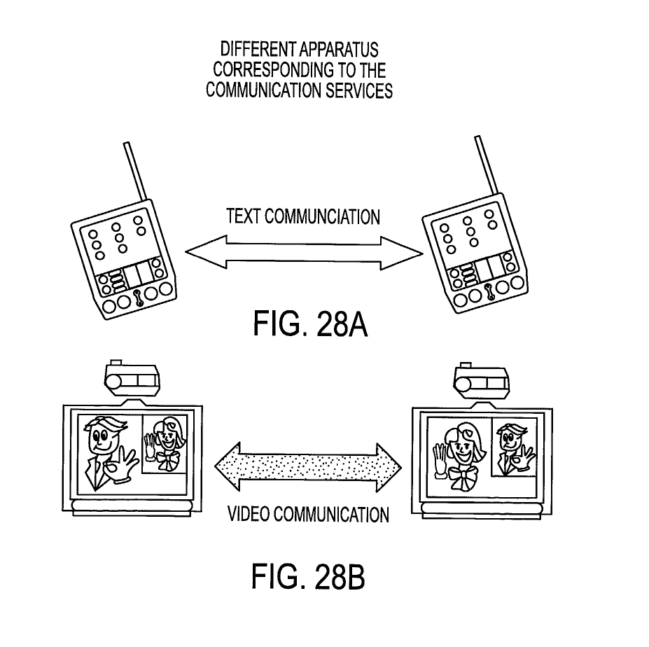

FIG. 29 illustrates a diagram with respect to a profile of the related art in the case where a moving person utilizes various multimedia communication services.

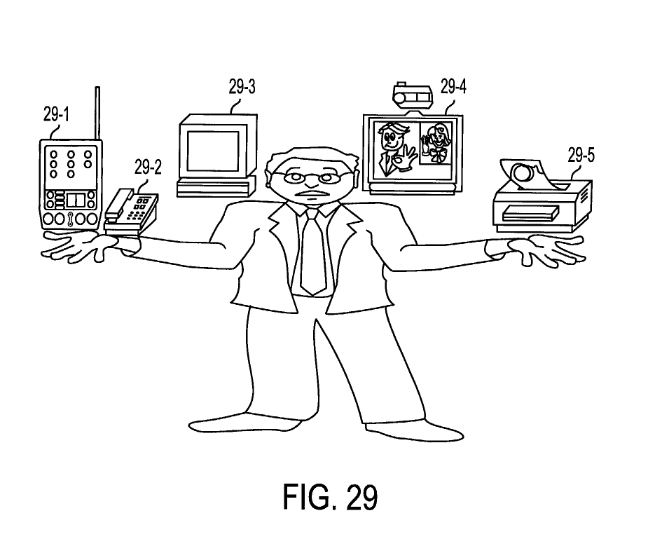

### DESCRIPTION OF THE PREFERRED EMBODIMENTS

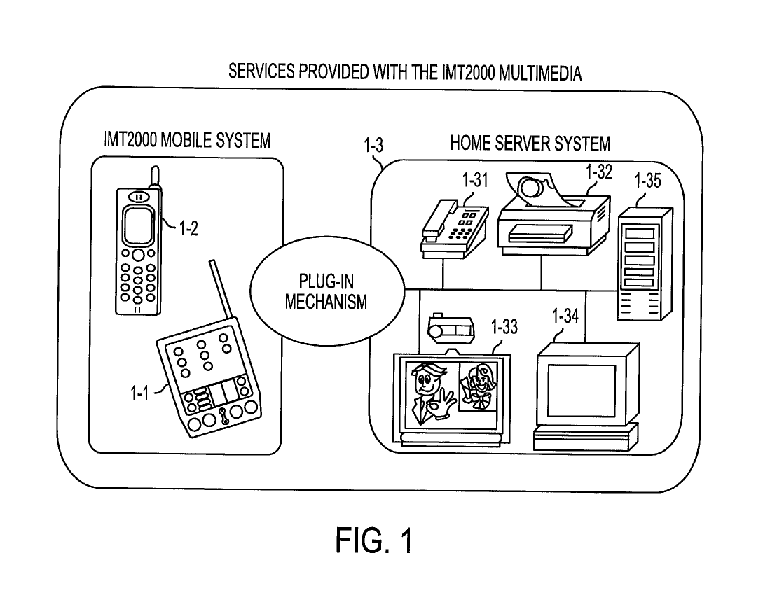

FIG. 1 illustrates an example of an apparatus used as a hand-held terminal for multimedia communication of the present invention. A personal digital assistant (PDA) 1-1, as an example of the hand-held terminal, and a hand-held telephone set 1-2 used in the IMT-2000 mobile system are incorporated with a multimedia home server system 1-3 through negotiation, and functions of each multimedia communication apparatus in the multimedia home server system 1-3, for example, multiple function telephone terminal 1-31, printer 1-32, a video communication apparatus 1-33, a personal computer 1-34 or the like are plugged in dynamically when required via the server 1-35, or directly, and each multimedia communication service offered from the IMT2000 mobile system can be used by utilizing the communication functions plugged in.

The multimedia home server system 1-3 explained above may be a fixed type multimedia home server system to be installed in the user house and in the public facilities, office as the working place, convenience store, hotel and public telephone box or the like, or a movable multimedia home server system to be installed in the public traffic means, private automobile, taxi, home distribution vehicle and truck or the like, or a rental multimedia home server system that is temporarily installed as the rental system of the multimedia apparatus comprising the multimedia home server.

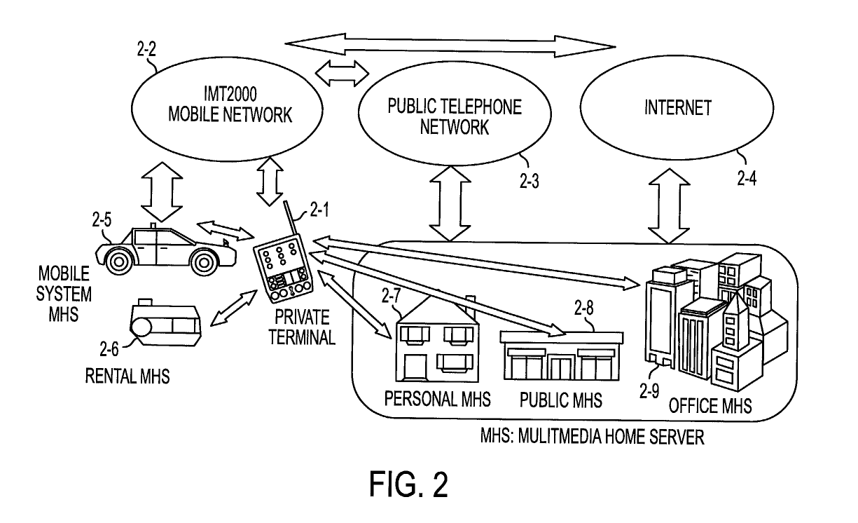

FIG. 2 illustrates a network connection structure of the hand-held terminal and server for multimedia communication of the present invention. A private hand-held terminal 2-1 for multimedia communication carried by a user has the IMT2000 mobile communication function, user authentication function and negotiation function and is connected, via the IMT2000 mobile network 2-2 and moreover the public line network 2-3 or Internet communication network 2-4 or the like, to the moving type multimedia home server (MHS) 2-5, rental multimedia home server (MHS) 2-6, private home multimedia home server (MHS) 2-7, public facilities multimedia home server (MHS) 2-8 or office multimedia home server (MHS) 2-9.

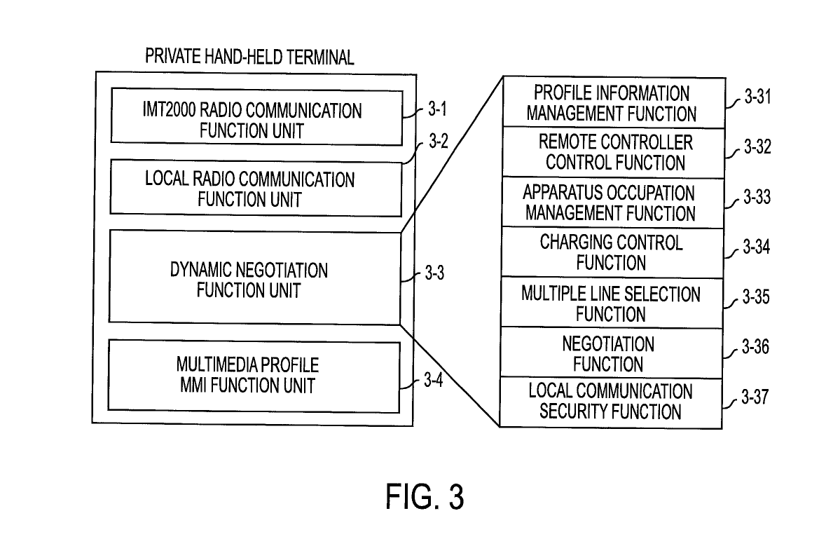

FIG. 3 illustrates a function block of the private hand-held terminal of the present invention. The private hand-held terminal of the present invention comprises an IMT2000 radio communication function unit 3-1, a local radio communication function unit (for example, Bluetooth communication function or the like as the interface for short-distance radio communication of about 10 m) 3-2, a dynamic negotiation function unit (said unit corresponds to a controller unit to negotiate with other communication apparatus by controlling the IMT2000 radio communication function unit 3-1 and so on) 3-3 and a multimedia profile man-machine interface (MMI) function unit 3-4.

The dynamic negotiation function unit 3-3 having a profile information management function 3-31, a remote controller control function 3-32 for controlling the peripheral apparatus such as the display unit, an apparatus occupation management function 3-33, a charging control function 3-34, a multiple line selecting function 3-35, a negotiation function 3-36 and a local communication security function 3-37.

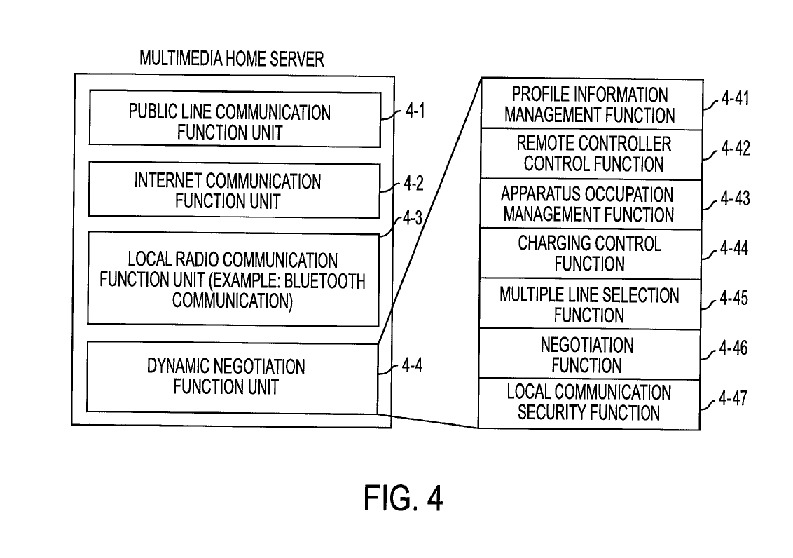

FIG. 4 illustrates a function block of a multimedia home server of the present invention. The multimedia home server comprises a public line communication function unit 4-1, an Internet communication function unit 4-2, a local radio communication function unit (for example, Bluetooth communication function or the like) 4-3 and a dynamic negotiation function unit (said unit corresponds to a controller unit to negotiate with other communication apparatus by controlling the public line communication function unit 4-1 and so on) 4-4

The dynamic negotiation function unit 4-4 of the server having, like the dynamic negotiation function unit 3-3 of the hand-held terminal, a profile information management function 4-41, a remote apparatus control function 4-42 for controlling the peripheral apparatus such as a display unit or the like, an apparatus occupation (reservation) management function 4-43, a charging control function 4-44, a multiple line selecting function 4-45, a negotiation function 4-46 and a local communication security function 4-47.

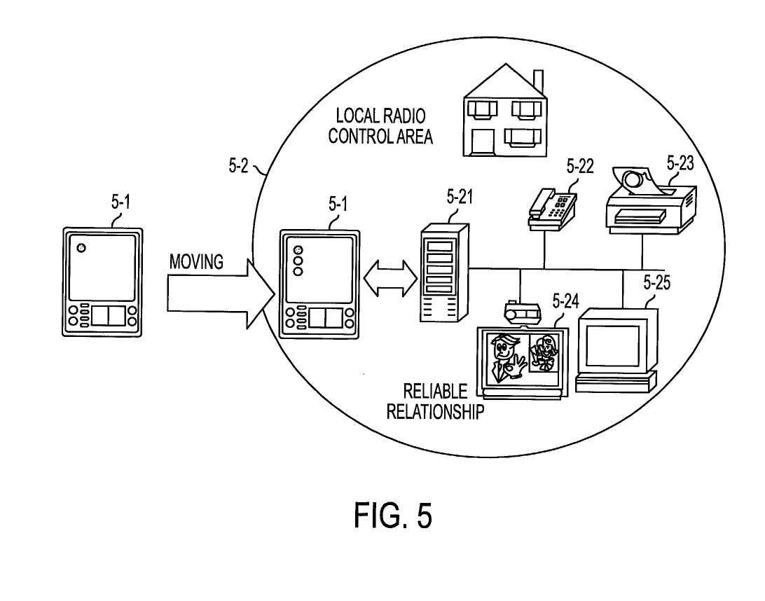

FIG. 5 illustrates an example of the automatic connection of the hand-held terminal of the present invention to a multimedia home server with the local radio link. When a user carrying the hand-held terminal 5-1 for multimedia communication moves to enter the local radio area (the width of the area is depending on the local radio communication function unit 3-2,4-3) 5-2 of its own house or working office, the multimedia home server 5-21 in the house or office automatically detects the existence of the hand-held terminal 5-1 within its area 5-2 (for example, the server 5-21 always or periodically generates the radio signal and the hand-held terminal receives this signal and returns the response signal to the server for the purpose of detection thereof) and automatically connects the hand-held terminal 5-1 with the local radio communication by using the local radio communication unit 3-2,4-2.

It can be skipped to perform strict user authentication for admitting the use of the multimedia home server 5-21. Because the multimedia home server 5-21 is installed in the house of the user of the hand-held terminal 5-1. The charge (or cost) for the communication between the hand-held terminal 5-1 and the multimedia home server 5-21 is free because of the limited communication on the private network.

The multimedia home server 5-21 (dynamic negotiation function unit 4-4) manages and stores the information of each multimedia communication apparatus (for example, each function of the multimedia communication apparatus is available or not available for the hand-held terminal 5-1) in a memory (S). This information is transmitted to the hand-held terminal 5-1 with the Bluetooth communication function of the local radio communication function unit 4-4 and thereby a list of functions of each multimedia communication apparatus (in the example of the figure, multiple function telephone terminal 5-22, printer 5-23, video communication apparatus 3-24, personal computer 5-25) and the condition (for example, each function of the media communication apparatus is available or not available) is displayed on the hand-held terminal 5-1 (although not figured, the hand-held terminal 5-1 has a display).

When input manipulation to select a function being available is performed at the hand-held terminal 5-1, such selected information is transmitted to the multimedia home server 5-21 with the Bluetooth communication function of the local radio communication function unit. The multimedia home server 5-21 enables the hand-held terminal 5-1 to use the selected function and updates the information stored in the memory (S) to indicate that the function is being assigned to the hand-held terminal 5-1. A user can communicate with other communication apparatus (communication terminal) using the communication performed by IMT2000 radio communication function unit 3-1 of the hand-held terminal 5-1 and the selected function of the multimedia communication apparatus.

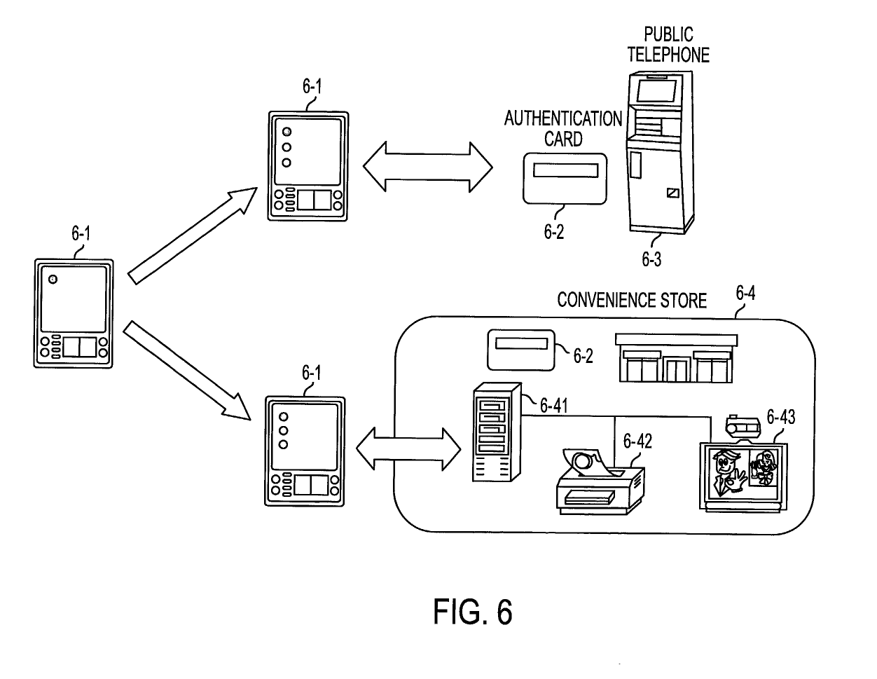

FIG. 6 illustrates an example wherein the hand-held terminal of the present invention is connected to the multimedia home server with the local radio link through the user authentication. This figure indicates an example of an application where the multimedia home server is connected to a public telephone set or installed in a convenience store. In this embodiment, it is determined using an authentication card 6-2 whether use of the multimedia communication apparatus is allowed to the user of the hand-held terminal 6-1 or not.

The authentication card stores terminal identification information of hand-held terminal 6-1 and user identification information and preferably includes a radio communication unit for making communication by radio link with the multimedia home server. In brief, it is also possible that the multimedia home server is provided with an output terminal to read such stored information. Here, it is enough for the multimedia home server to be provided, corresponding to the structure of the authentication card, with a connector or the like that can electrically be connected with the radio communication unit and output terminal. A modification suitable for other communication modes can be realized easily in such a manner that a magnetic tape is attached to the authentication card and it is then read with a magnetic information reader of the multimedia home server.

Meanwhile, when communication and transmission of information are conducted in the mode explained above between the authentication card and multimedia home server, the multimedia home server 6-3,6-41 (dynamic negotiation function unit 4-4) determines whether the terminal identification information (a user identification information) satisfies the predetermined conditions or not. When the conditions are satisfied, the multimedia home server 6-3,6-41 enables the hand-held terminal 6-1(in other words the user of this terminal) to use the multimedia communication apparatus (6-3,6-42,6-43) under the management of its own.

Namely, the multimedia communication apparatus obtains and stores the terminal identification information (the user identification information) stored in the authentication card and thereafter allows application request for the multimedia communication apparatus under the control thereof issued from the hand-held terminal having the terminal identification information. As an example of the multimedia home server, a multimedia home server (not illustrated) in the public telephone set 6-3 or the server 6-41 of the multimedia server system 6-4 installed in the convenience store may be listed. If the multimedia communication apparatus has the dynamic negotiation function unit and local radio communication function unit, then the multimedia communication apparatus can negotiate directly with the hand-held terminal without the multimedia home server.

In the convenience where the multimedia server is used by multiple users, it is necessary to correctly identify the person who makes the charges. Therefore, a user utilizing the multimedia home server (the multimedia communication apparatus) is authenticated using the information storage medium such as the authentication card and charges are calculated for each user by using the terminal identification information (the user identification information). The function to authenticate each terminal (user) and calculate the charges may be given to another apparatus connected to the multimedia home server, in addition to the multimedia home server.

Moreover, it is also possible that an electronic money management function is mounted to an information storage medium such as the authentication card or the like, the charges such as application fee of multimedia home server in the public telephone set or in the convenience store, application fee of each multimedia communication apparatus and communication charge of the multimedia communication used are collected from the electronic money data in the information storage medium such as the authentication card explained above,

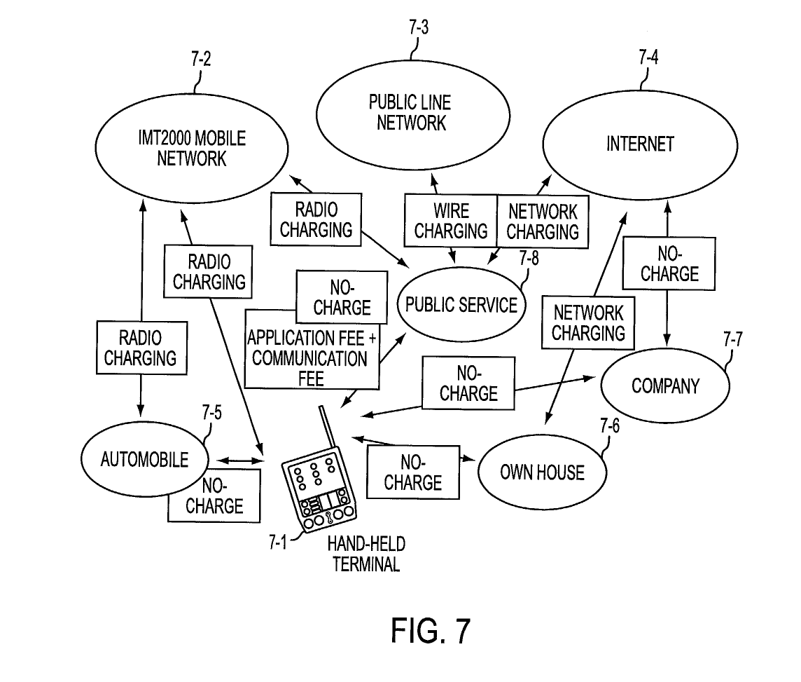

FIG. 7 illustrates an example of the charging system (cost allocation) of multimedia communication in the present invention. For the packet communication of the text base conducted with the hand-held terminal 7-1 of the present invention via the IMT2000 mobile network 7-2, the radio communication fee is charged to an owner of the hand-held terminal 7-1 through the IMT2000 mobile network 7-2.

In the case where the hand-held terminal 7-1 is connected to the multimedia home server 7-5 mounted in a private vehicle to utilize the multimedia communication via the IMT2000 mobile network 7-2, the radio communication fee of the multimedia communication is charged to the owner of the multimedia home server 7-5 of the vehicle. It's usual that the owner of the multimedia home server 7-5 of the vehicle is the same as the owner of the hand-held terminal 7-1.

In the case where the hand-held terminal 7-1 is connected to the multimedia home servers 7-6, 7-7 in its own house or in the company office, for example, to utilize the multimedia communication through the Internet communication network 7-4, the connection fee used for multimedia communication is charged to an owner of the multimedia home servers 7-6, 7-7 of the house or company office.

In the case where the hand-held terminal 7-1 is connected to the multimedia home server 7-8 for public services to utilize the multimedia communication through the IMT2000 mobile network 7-2, public link network 7-3 or Internet communication network 7-4, the charges such as the radio communication, wire communication or Internet connection fee used for multimedia communication, application fee of the public multimedia home server and application fee of the multimedia communication apparatus and the multimedia communication charge are collected from an electronic money of the owner of the hand-held terminal 7-1.

When a plurality of communication networks such as the IMT2000 mobile network 7-2, public link network 7-3 and Internet communication network 7-4 are available from the public multimedia home server 7-8, the application fees of respective communication networks are displayed on the hand-held terminal 7-11. Therefore a user can refer to the application fee and communication quality of each communication network and can select the best communication network.

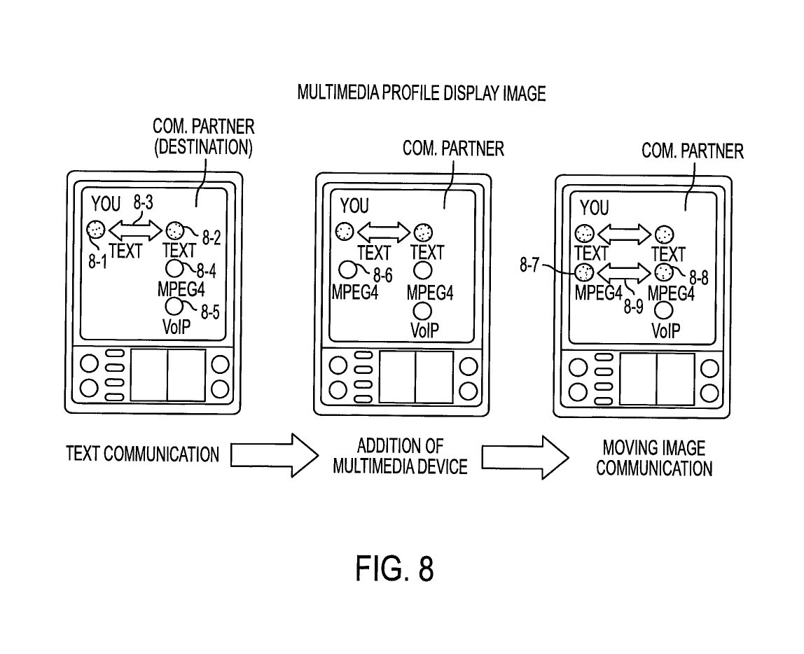

FIG. 8 illustrates an example of the display image at the hand-held terminal of the present invention. The dynamic negotiation function unit 3-3 controls the display to display these images with profile information management function 3-31. The area described as “You” in the left half of each figure indicates the state (for example, “occupied”, “using”, selectable) of each multimedia communication function at the relevant hand-held terminal side.

The state “selectable” means that the hand-held terminal can reserve or occupy the function of the multimedia communication apparatus. However this hand-held terminal is never assured for reliable use and it cannot be used when the other hand-held terminal issues the reservation (occupation) request previously to the multimedia home server. Therefore, in order to assure that its own hand-held terminal reserves (occupies) the multimedia communication function, it is requested to previously send the reservation request signal (this signal is transmitted from the local radio communication unit 3-2) and when the acknowledgment signal is returned from the multimedia home server in response to such request, the display image corresponding to the requested function changes to “occupied”. The hand-held terminal has a memory (H) for storing information with respect to the state of the function and the dynamic negotiation function unit 3-3 updates the information with the profile information management function 3-31.

Of course the dynamic negotiation function unit of the multimedia home server also updates the information stored in the memory (S) of its own with the profile information management function 4-41.

The state “occupied” means that the hand-held terminal has already reserved the function of the multimedia communication apparatus. When once the multimedia communication function is reserved by the hand-held terminal, if another hand-held terminal issues a request to utilize the same function of the multimedia home server, the request will be denied by the multimedia home server.

The state “using” means that the hand-held terminal is using the function of the multimedia communication apparatus now.

On the other hand, the area described as “Destination” in the right half of each figure indicates the state of each multimedia communication function at the destination hand-held terminal (partner communication terminal) side. The state information displayed at the area “Destination” is sent from the partner terminal (for example the IMT2000 radio communication function unit transmits the radio signal including the state information under the control of the dynamic negotiation function unit) at the time of starting the communication or during the communication.

Therefore, a user of the relevant hand-held terminal can recognize what kind of multimedia communication function can be used by the partner terminal or what kind of multimedia communication is used now between the relevant hand-held terminal and the partner terminal or what kind of multimedia communication function can be reserved by the partner terminal. Herein after, this figure is called the multimedia profile display image. A profile in which a new kind of media communication function is added during the communication will be indicated in the sequence of (A), (B) and (C). A profile where the class of media communication having been used is deleted is not illustrated but it can also be realized in the same manner.

The multimedia profile information displays “selectable” condition, “occupied” condition or “using” condition for each multimedia communication function with the display method using different colors and flickering period depending on change of such conditions and notifies the state of the multimedia communication function to the user of the relevant hand-held terminal. In the case where a plurality of multimedia communication apparatuses of the same kind are used, it is possible that the multimedia home server transmits the information indicating to which multimedia communication apparatus each multimedia communication function belongs to the hand-held terminal. The hand-held terminal receives such information and displays on its own display.

FIG. 8(A) displays that the text data communication function is reserved with the relevant hand-held terminal and the communication terminal of the communication destination (black circles 8-1, 8-3) and these are communicating actually with the text data communication function (arrow mark in both directions 8-3) and also indicates (white circles 8-4, 8-5) that the video communication function (MPEG4) and Internet telephone communication function (VoIP) are selectable in the communication terminal of the communication destination.

The hand-held terminal accepts the user's manipulation for addition and deletion of the available multimedia communication function and freely changes the multimedia communication function available at this hand-held terminal. FIG. 8(B) illustrates the display image when the video communication function (MPEG4) is added in the relevant hand-held terminal, indicating that the video communication function (MPEG4) of the relevant hand-held terminal is selectable (white circle 8-6).

FIG. 8(C) indicates that the text data communication function is reserved with the relevant hand-held terminal and the communication terminal of the communication destination, moreover the text data is in use for communication, the video communication function (MPEG4) is reserved with both apparatuses (black circles 8-7, 8-8) and moreover the video communication function (MPEG4) is in use for communication (both direction arrow 8-9).

The detail information of each multimedia communication function is displayed at the hand-held terminal in response to predetermined manipulation (of the multimedia profile MMI function unit). Herein the detail information is transmitted via the multimedia home server from the multimedia communication apparatus in response to the request from the hand-held terminal to the multimedia communication apparatus via the multimedia home.

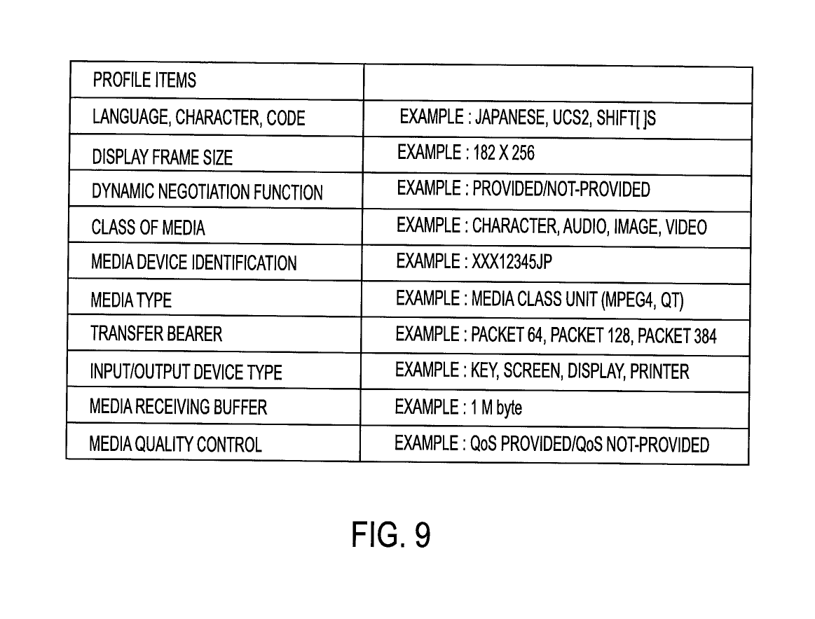

FIG. 9 illustrates the multimedia profile information. The items of the multimedia profile information include class of language and its character code, display frame size, provided/not-provided of negotiation function, media apparatus identification information for identifying the communication apparatus of different multimedia communication functions, media type indicating the system/protocol type of each multimedia communication class, kind of transfer bearer, input/output device type, receiving buffer size and information of communication quality control (Qos provided/not-provided).

This multimedia profile information is updated dynamically both in the relevant hand-held terminal and the communication terminal of the communication partner depending on variation of the profile such as addition and deletion or the like of the multimedia communication function. The multimedia profile display image of the hand-held terminal is displayed on the basis of this multimedia profile information.

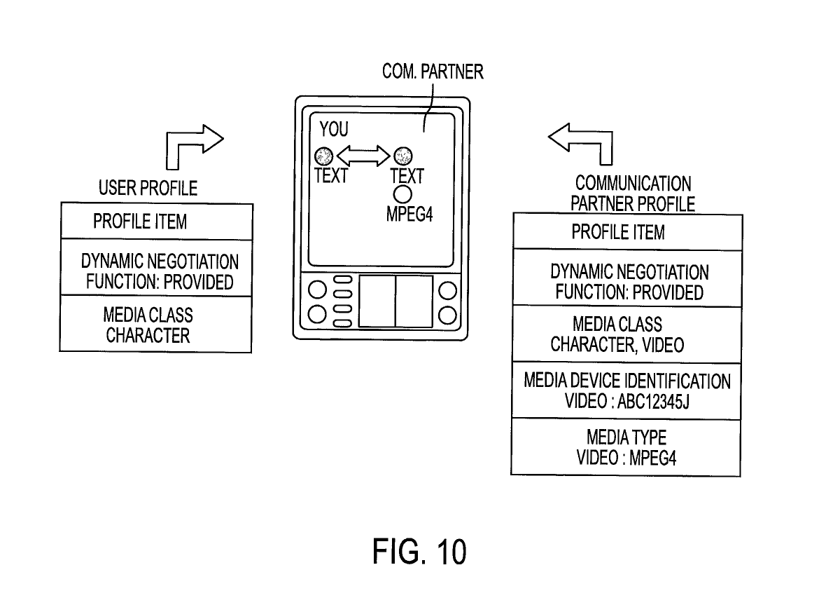

FIG. 10 illustrates a display example of the multimedia profile display image that is displayed depending on the multimedia profile information of the relevant hand-held terminal user side and communication partner. However, in the multimedia profile display image, only the information of the important items (for example, media class, media type or the like) among the multimedia profile information of the hand-held terminal user and communication partner.

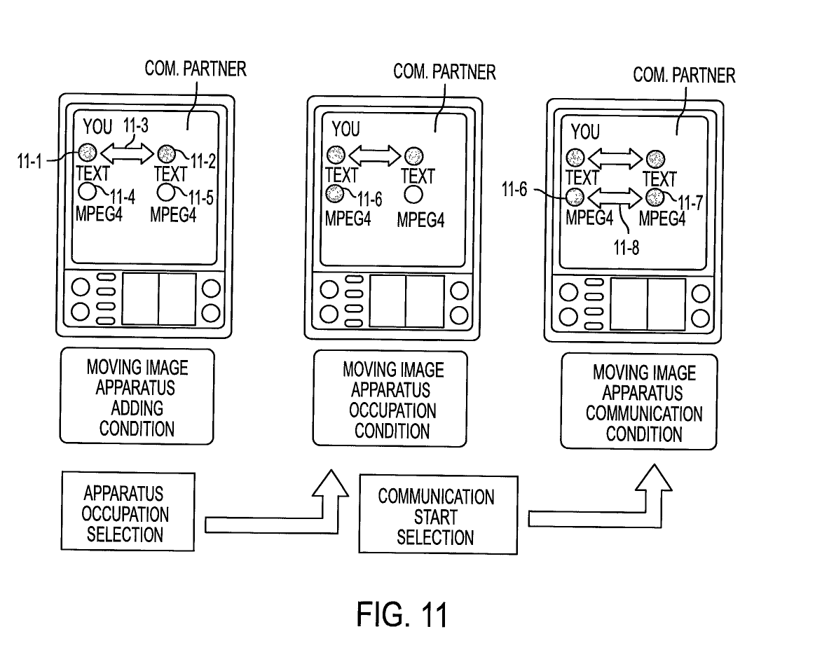

Flow of the additional process of a new multimedia communication mode during the communication of the hand-held terminal of the present invention will be explained mainly for the display image with reference to FIG. 11. FIG. 11(A) illustrates the multimedia profile display image of the relevant hand-held terminal and communication terminal of the communication destination.

As illustrated in FIG. 11(A), the relevant hand-held terminal and the communication terminal of communication destination are communicating with the text communication function (both direction arrow mark 11-3), wherein the hand-held terminal has the text communication function. And the video communication function (MPEG4) is available in both the relevant hand-held terminal and the communication terminal of communication destination (white circles 11-4, 11-5). Though the hand-held terminal and the communication terminal don't have the video communication function reserved, the multimedia communication apparatuses of each side of the hand-held terminal and the communication terminal have the video communication function.

Under this condition, a user can try to reserve the added video communication function (MPEG4) through the negotiation with the server. If the predetermined manipulation is performed to reserve the added video communication function (MPEG4), then the request signal for reserving the video communication function (MPEG4) is transmitted to the multimedia home server by the IMT2000 radio communication function unit controlled by the dynamic negotiation function unit.

This multimedia home server determines whether this request can be accepted or not by referring to the management information (stored in the memory (S)) of the multimedia communication apparatus to be controlled. When this request is accepted (namely in the case that the state of the function is ‘selectable’), the management information (stored in the memory (S)) for the video communication function (MPEG4) is changed to the “occupied” condition and the multimedia communication terminal transmits the response signal indicating that request has been accepted to the hand-held terminal.

Therefore this function is no longer available for the other hand-held terminal without the reservation being released.

If it is possible to provide the relevant function to N (N is the natural number) hand-held terminals, the multimedia home server provides the relevant function to other hand-held terminals until the number of terminals provided the relevant function equals N. Whether the number of terminals has equaled N or not is determined with comparison of the predetermined number N and the number counted at the time of reservation of the relevant function by a new hand-held terminal.

When the relevant hand-held terminal (local radio communication function unit) receives the response signal from the multimedia home server, it is reflected on the display image (also it is reflected to the information of the memory (H)) that the relevant hand-held terminal has reserved the video communication function (MPEG4) as illustrated in FIG. 11(B) (black circle 11-6) by the dynamic negotiation function unit.

Under this condition, a user recognizes that the video communication function (MPEG4) is available. When this function is reserved, state change information is also transmitted to the communication partner from the relevant hand-held terminal or the multimedia home server. Herein the state change information is transmitted by the IMT2000 radio communication function unit of the hand-held terminal or the public line communication function unit (internet communication unit) of the server. Thereby the multimedia profile information of the communication destination in the display image of the communication partner terminal is also updated.

When a user of the relevant hand-held terminal having recognized the reservation of the video communication function (MPEG4) desires start of communication using the video communication function (MPEG4), this user manipulates the manipulation unit of the hand-held terminal. Thereby, the signal requesting the communication using the video communication function (MPEG4) is transmitted to the communication partner by the IMT2000 radio communication function unit. When the user of the communication destination manipulates the predetermined manipulation at the communication terminal to accept this request, the information to accept this request is transmitted to the relevant hand-held terminal and the video communication is started between the relevant hand-held terminal by the IMT2000 radio communication function unit of the partner communication terminal and the communication partner terminal on condition that the state of the video communication function for the relevant terminal and the communication partner is “occupied”. Here, an example of structure where manipulation by user is determined as the condition to start each operation has been explained above, but it is also possible that after the reservation request for the multimedia home server is issued, a part or the whole of the manipulations can progress automatically to the next step even if any manipulation is not performed.

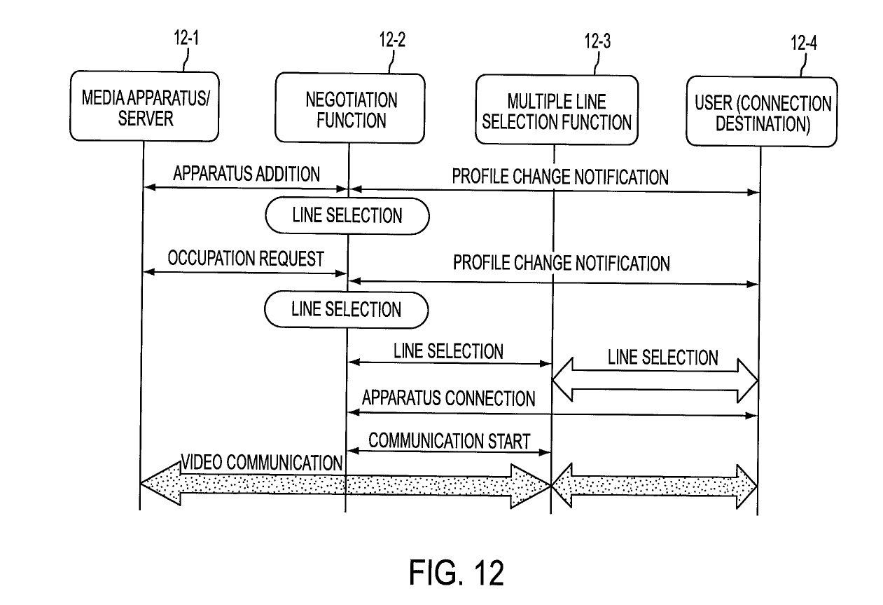

Next, the negotiation procedures will then be explained in detail. FIG. 12 illustrates the dynamic communication service function adding negotiation procedures in relation to the present invention. When it is detected with the management function of the dynamic negotiation function unit that a new multimedia communication apparatus is connected to the multimedia home server or the function being reserved by the other hand-held terminal is released, such change information is notified to the negotiation function 12-2 (of the dynamic negotiation function unit 3-3) of the hand-held terminal (here, it is assumed that the apparatus is added, and the relevant hand-held terminal not reserved with the other terminal among the functions of the apparatus added as the apparatus additional information notifies the information of the available functions).

The hand-held terminal having received this change information reflects the change of the profile information to the display image (also to the information of the memory (H)) and notifies this change also to the communication partner. Here, when a user manipulates the hand-held terminal to reserve the function which is newly added or has been selectable but is not yet reserved, the negotiation function 12-2 notifies the “occupation request” to the multimedia home server (media apparatus/server) 12-1. After the acceptance of this occupation request the function reserved of the multimedia communication apparatus is not reserved to the other user.

After the function of the multimedia apparatus is reserved, the home server transmits change information to the hand-held terminal and transmits change information of profile to the communication terminal 12-4 of the connection destination terminal, herein change information of profile can be transmitted to the connection destination terminal by the hand-held terminal. The hand-held terminal received change information changes the display image concerning its own multimedia profile. When the line selecting manipulation is performed with a user of the relevant hand-held terminal, the command of“line selection” is notified to the multiple line selection function 12-3 (of the dynamic negotiation function unit) and the multiple line selection function 12-3 selects a new line for the communication terminal 12-4 of the connection destination user to acquire the transmission line. Herein IMT2000 radio communication function unit 3-1 ( controlled by the dynamic negotiation function unit 3-3) transmits the radio signal to request a new transmission line to the base station of the IMT2000 network.

The negotiation function 12-2 (of the dynamic negotiation function unit 3-3) performs the negotiation with the communication terminal 12-4 of the connection partner in regard to the connection of the new media communication apparatus, then starts the communication utilizing the new function of the multimedia communication apparatus with the communication terminal 12-4 of the connection destination user.

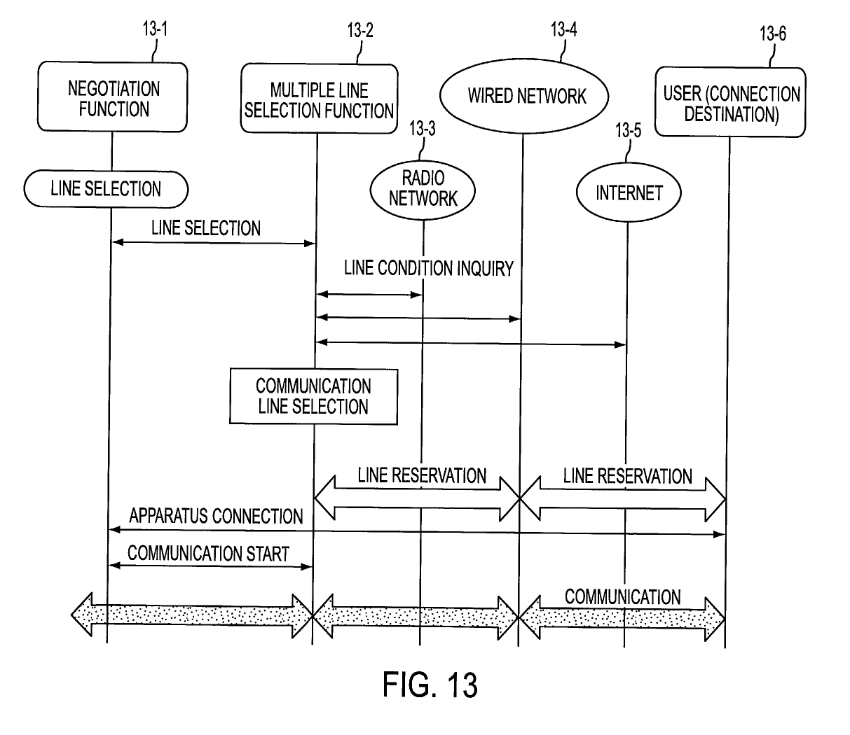

FIG. 13 illustrates the communication line selection process procedures in the hand-held terminal of the present invention. The multiple line selection function 13-2 (of the dynamic negotiation function unit 3-3) inquires of the radio network the line condition and charging information of each network (radio network 13-3, wire network 13-4, Internet communication network 13-5) to each network (radio network 13-3, wire network 13-4, Internet communication network 13-5.

However, in regard to the charging information, it is also possible to form the structure to extract the charging information by making access to the server or the like previously holding the charging information without any actual inquiry to the network.

The line condition and charging information are notified to the user of the hand-held terminal (namely the information is displayed on the display of the hand-held terminal) and the user designates the line to use (namely the user of the hand-held terminal performs the predetermined manipulation to the hand-held terminal). However, it is also possible to automatically select the optimum line without any user's selection manipulation by previously programming the desired line selection logic in the hand-held terminal.

In this figure, an example where the wire network 13-4 is selected is illustrated. The line is acquired for the connection destination user 13-6 via the wire network 13-4. The negotiation function 13-1 (of the dynamic negotiation function unit 3-3) performs the negotiation with the communication terminal 13-6 of the connection destination user and the media communication apparatus and notifies the “Communication start” to the multiple line selection function 13-2 in order to start the communication for the communication terminal 13-6 of the connection destination user using the function of the media communication apparatus.

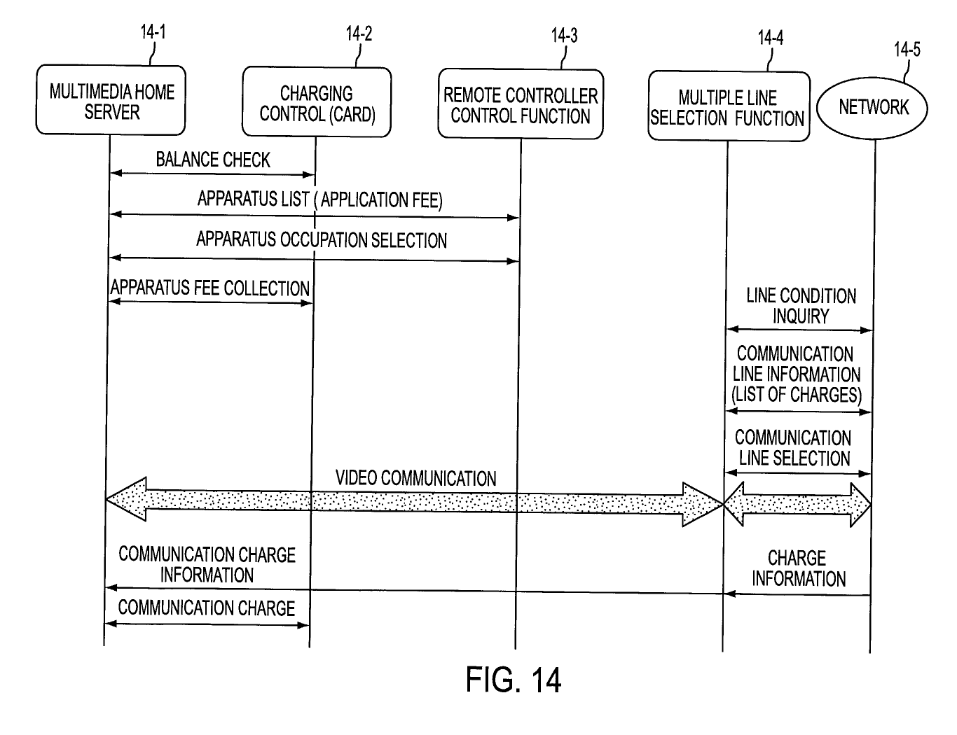

FIG. 14 illustrates the procedures of charge collection process and line selection process in the present invention. The charge collecting process is performed when the public multimedia home server 14-1 is used. The charging process to the hand-held terminal user is realized with the charging control function comprised in the user authentication card 14-2, herein the card 14-2 is inserted in the multimedia home server 14-1.

The user authentication card 14-2 stores the money information such as electronic money (cash) and the public multimedia server collects the multimedia home server application fee, multimedia communication apparatus application fee and multimedia communication charge from the electronic money of the user authentication card 14-2.

The multimedia home server 14-1 checks the balance of electronic money of the user authentication card 14-2 and controls the local radio communication function unit to transmit signals including information with respect to a list of the function of the available multimedia communication apparatuses and its application charges to the remote controller control function 14-3. The dynamic negotiation function unit controls the display of the hand-held terminal to display the list of the available multimedia communication apparatuses and its application charges. If the multimedia home server 14-1 receives the request signal to reserve the function listed from the hand-held terminal in response to the manipulation of the user, the multimedia home server 14-1 reserves the function and collects the application charge of the function as the electronic money from the user authentication card 14-2.

When line selection manipulation is done by the user, the multiple line selection function 14-4 controls the hand-held terminal to inquire of the communication network 14-5 the line condition and the communication line information (list of charges) is notified to the hand-held terminal.

When the communication line selecting manipulation is done on the hand-held terminal, the multiple line selection function 14-4 selects the selected line to start the communication with the communication partner for the video communication, for example, with the communication partner. Namely, the multimedia communication apparatus having the video communication function receives a video communication signal via the hand-held terminal and the multimedia communication apparatus displays images on the display.

The multimedia home server 14-1 collects the fee for the use of the multimedia communication apparatus as the electronic money from the user authentication card 14-2.

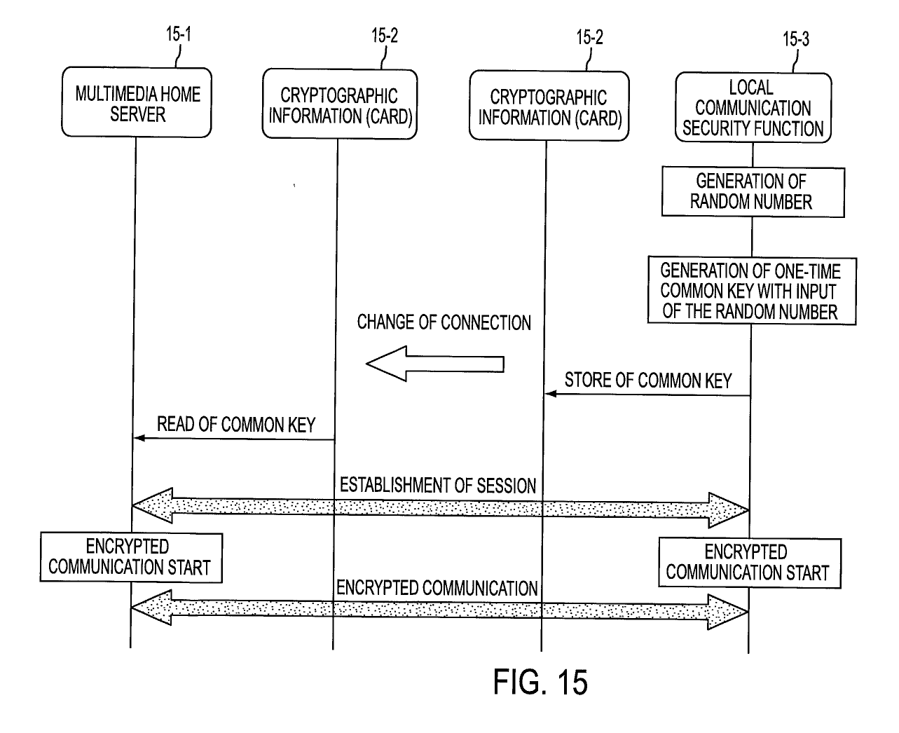

FIG. 15 illustrates a security ensuring process procedure in the present invention. The hand-held terminal 15-3 and multimedia home server 15-1 is also provided, as the local communication security function, with the function for the cryptographic communication using a common key and moreover generate a random number for each operation as the pre-manipulation for establishing the session in the hand-held terminal and also generate the one-time common key using such random number as the input in view of preventing re-use through robbery of the user authentication card or the like.

As the common key cryptographic algorithm, an ordinary common key cryptographic algorithm such as RC4 can be used. The one-time common key generated is stored as the cryptographic information within the user authentication card 15-2. After the session is established between the multimedia home server 15-1 and the hand-held terminal 15-3, the communication data is encrypted/decoded using the common key stored in the user authentication card for the purpose of cryptographic communication.

The cryptographic communication handling process can be alleviated and the time required for starting the local communication can also be shortened by storing the cryptographic communication information to the user authentication card 15-2 and then connecting the user authentication card 15-2 to the multimedia home server 15-1 by the user.

Since the one-time common key is effective for only the single session, if the user authentication card is left, for example, at a convenience store, this user authentication card cannot be used for the cryptographic communication with the hand-held terminal carried with the other person. Moreover, it can also be prevented that the other person illegally use the electronic money of the user authentication card by presetting that the charge collecting process function is effective only for the cryptographic communication using the one-time common key.

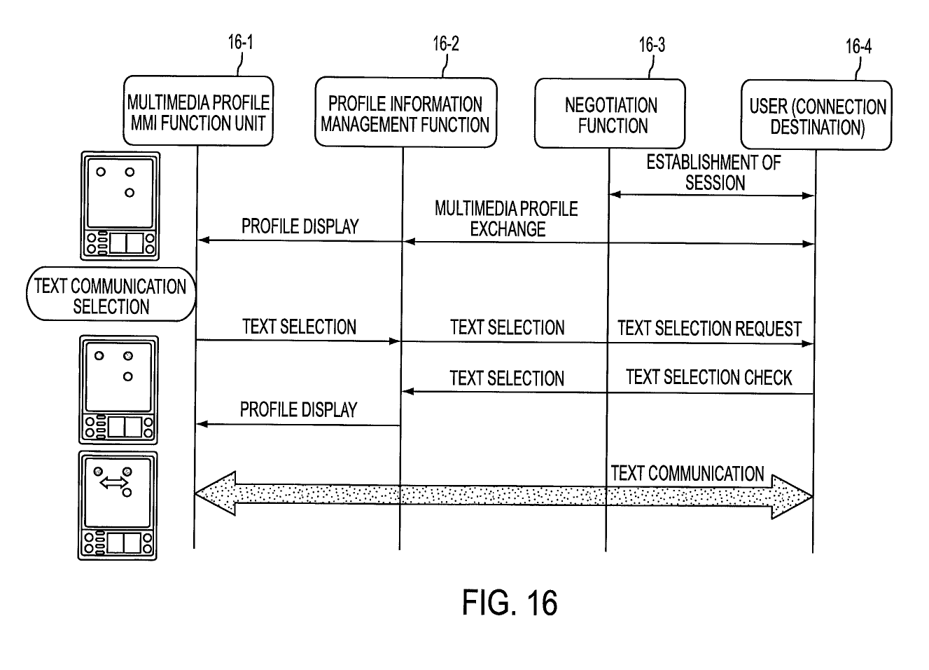

Thereafter, an operation example of the multimedia communication of the present invention will be explained. FIG. 16 illustrates an example of the initial communication process procedure of the present invention. After the negotiation function 16-3 of the hand-held terminal establishes the session with the communication terminal 16-4 of the communication destination user, the profile information management function 16-2 of the hand-held terminal exchanges the multimedia profile information with the communication terminal of the communication destination user and also displays the profile on the display unit as the profile man-machine interface unit 16-1 of the relevant hand-held terminal.

When the text communication is selected with the relevant hand-held terminal user, the selected information is notified to the communication terminal 15-4 of the communication destination user by the profile information management function 16-2 and when the communication destination user performs the selection check manipulation for the text communication, the such text selection check is notified to the hand-held terminal. Here, the profile information management function 16-2 controls the display (as the profile man-machine interface unit 16-1) of the hand-held terminal. Thereafter, the text communication is started between the relevant hand-held terminal and communication destination user communication terminal with the communication start manipulation of the relevant hand-held terminal user.

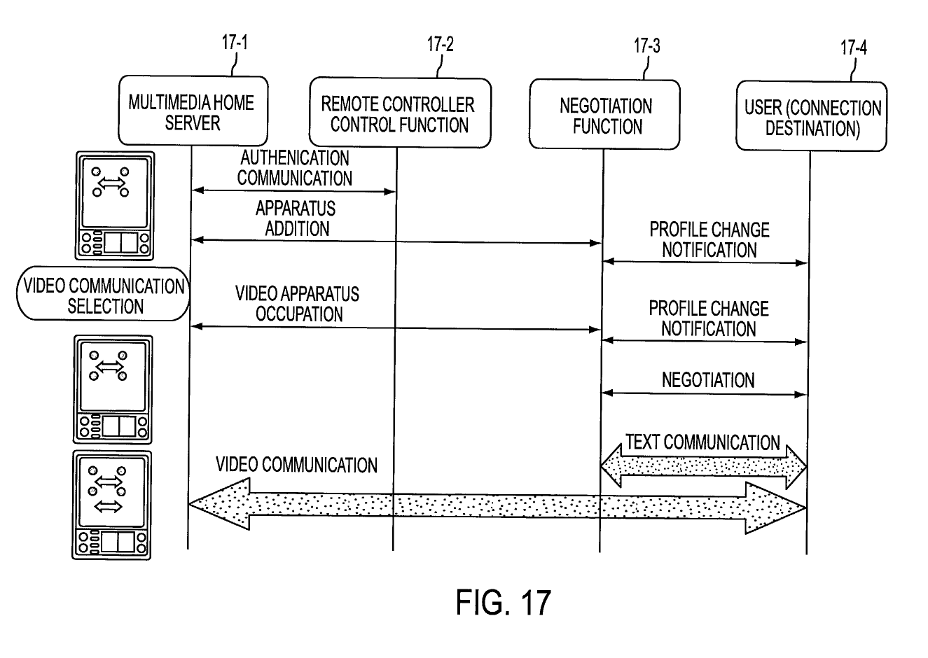

FIG. 17 illustrates an example of the connection procedure with the user authentication in the present invention. When the additional manipulation of the video communication function belonging to the multimedia communication apparatus is performed after the user authentication communication between the public multimedia home server 17-1 and the remote controller control function 17-2 of the hand-held terminal, the negotiation function 17-3 of the hand-held terminal notifies a change of profile to the connection destination user communication terminal 17-4.

Moreover, when the manipulation for reserving the video communication apparatus is performed, the negotiation function 17-3 of the hand-held terminal notifies a change of profile to the connection destination user communication terminal 17-4. Thereafter, the negotiation function 17-3 negotiates with destination user communication terminal 17-4 and the hand-held terminal starts the video communication simultaneously with the preceding text communication between the connection destination user communication terminal 17-4

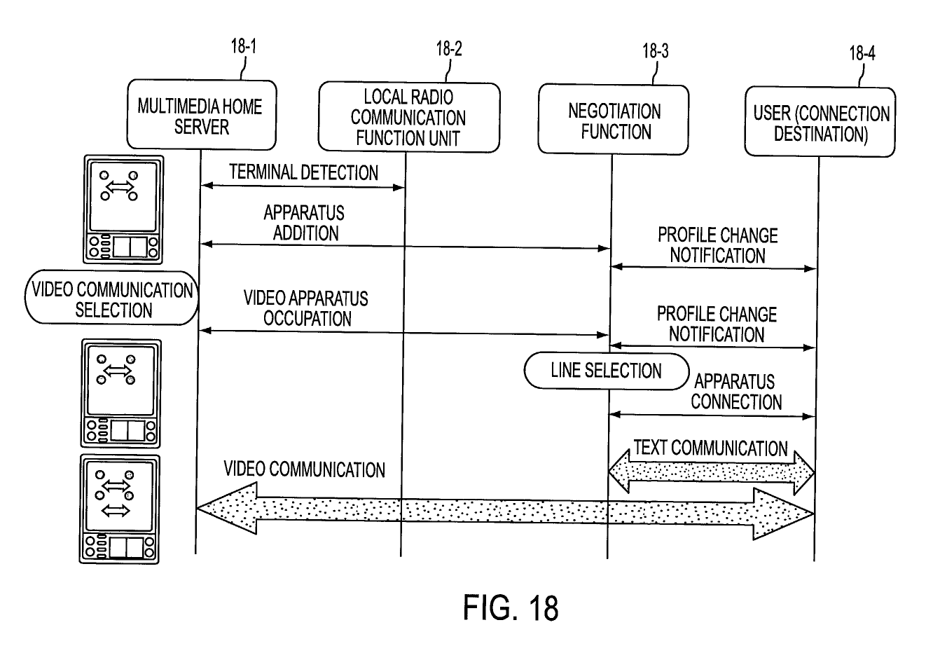

FIG. 18 illustrates an example of automatic connection procedure by local communication in the present invention. In the case of connection between the multimedia homes server installed under the private environment in the reliable relationship with a user such as within own house or working office and the hand-held terminal, when a user carrying the hand-held terminal enters the local radio control area in the private environment, the multimedia home server 18-1 in such private environment automatically detects existence of the hand-held terminal with exchange of a radio signal with the local radio communication function unit of this hand-held terminal and automatically forms a radio line with the hand-held terminal. The subsequent connection procedure is similar to the connection procedure illustrated in FIG. 17 explained above and therefore further explanation will be omitted here.

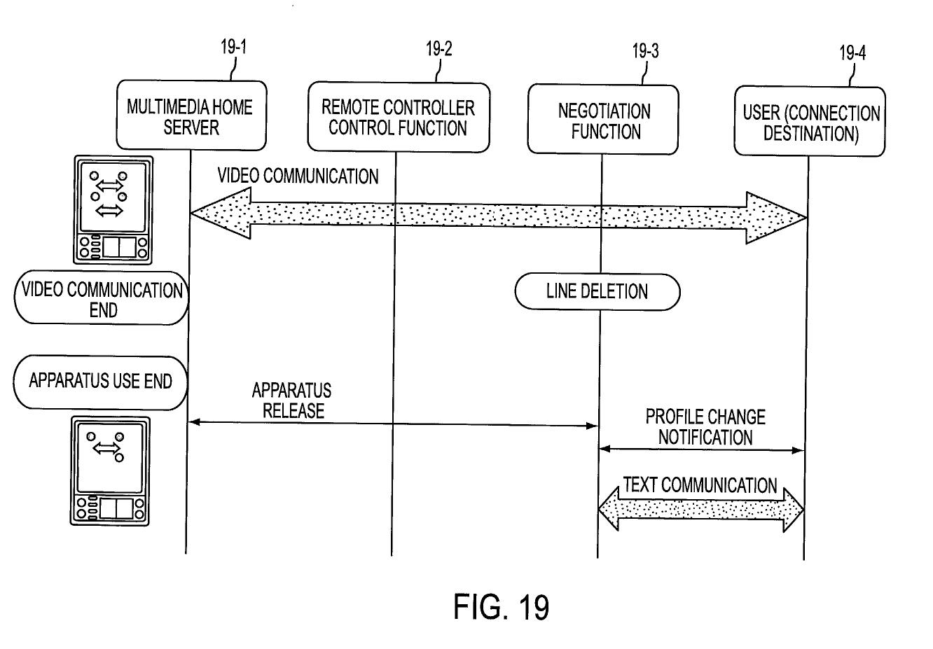

FIG. 19 illustrates an example of the multimedia communication disconnection procedure of a user authentication connection in the present invention. When video communication conducted between the multimedia home server 19-1 and the connection destination user communication terminal 19-4 is completed, the negotiation function 19-3 of the hand-held terminal disconnects (deletes) the line used for the video communication and transmits the video communication apparatus release signal to the multimedia home server 19-1 to complete the use of this apparatus and moreover notifies a change of profile to the connection destination user communication terminal 19-4.

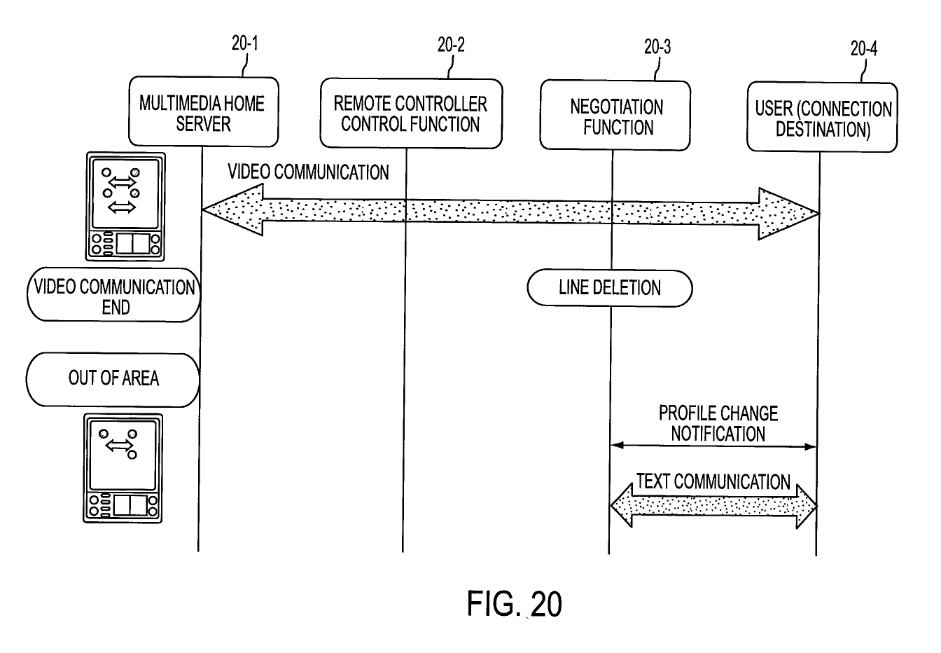

FIG. 20 illustrates an example of the multimedia communication disconnection procedure of the local communication automatic connection in the present invention. When the video communication conducted between the multimedia home server 20-1 having the function of video communication and connection destination user communication terminal 20-4 is completed, the negotiation function 20-3 of the hand-held terminal disconnects (deletes) the line used for video communication. If the hand-held terminal moves to the outside of the radio area, then the hand-held terminal can't use the function of the multimedia communication apparatus (or the server). In that case, the negotiation function 20-3 notifies a change of profile to the connection destination user communication terminal 20-4.

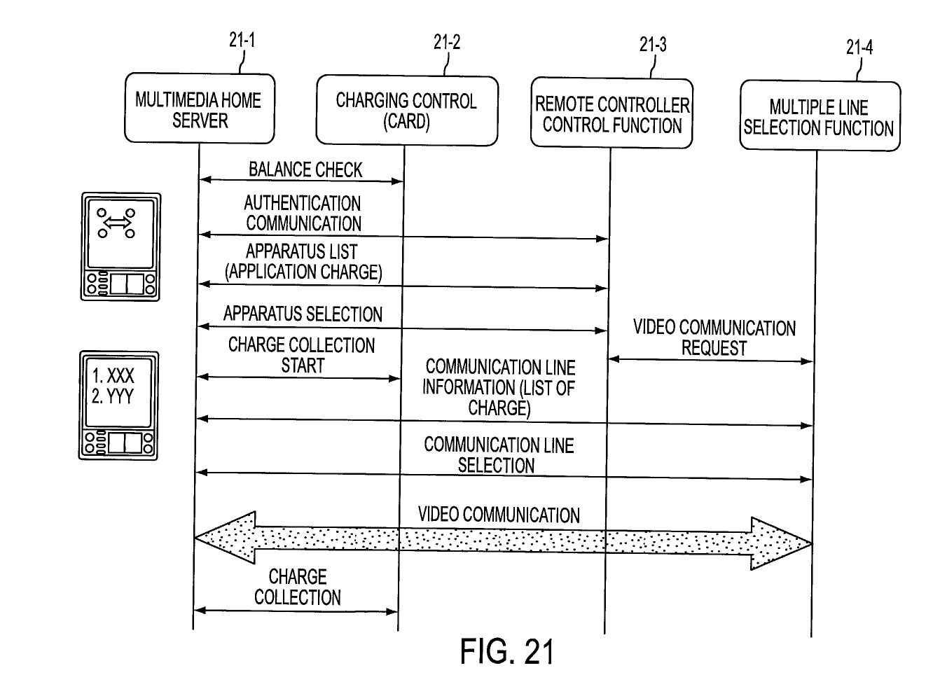

FIG. 21 illustrates an example of the charge collecting process procedure in the present invention. The charge collecting process is executed as explained above when the public multimedia home server 21-1 is used. The communication charge of a plurality of available lines is displayed on the hand-held terminal and the communication charge of the line selected by the user is collected from the electronic money of the user authentication card 21-2. In the case where the multiple line selection function 21-4 of the hand-held terminal automatically selects the line depending on the line selection logic preset by a user, the communication charge is collected from the electronic money or the like depending on the line automatically selected. Since the charge collecting process procedure is explained with reference to FIG. 14, same explanation is omitted here.

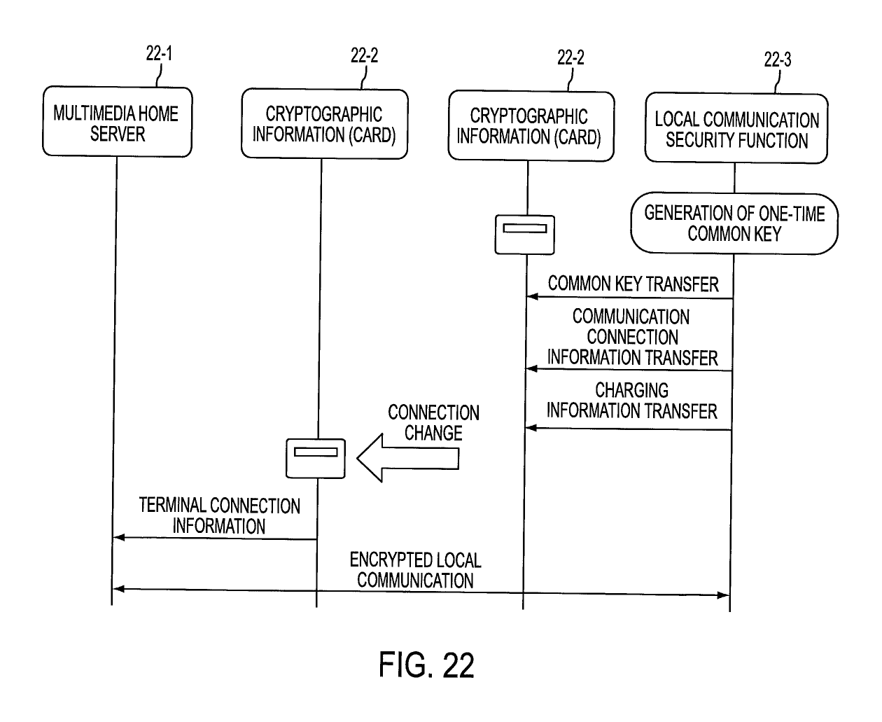

FIG. 22 illustrates an example of the security ensuring process procedure in the present invention. The security ensuring process is also performed when the public multimedia home server 22-1 is used. As explained with reference to FIG. 15, the one-time common key is generated with the local communication security function 22-3 of the hand-held terminal.

The one-time common key generated in the hand-held terminal is transferred to the user authentication card 22-2 and moreover the local communication security function 22-3 of the hand-held terminal transfers the communication connection information and charging information to the user authentication card 22-2. A user then connects the user authentication card 22-2 storing such information to the multimedia home server 22-1 and the multimedia home server 22-1 receives the hand-held terminal connection information from the user authentication card 22-2 and thereby the encrypted local communication can be made between the multimedia home server 22-1 and the hand-held terminal.

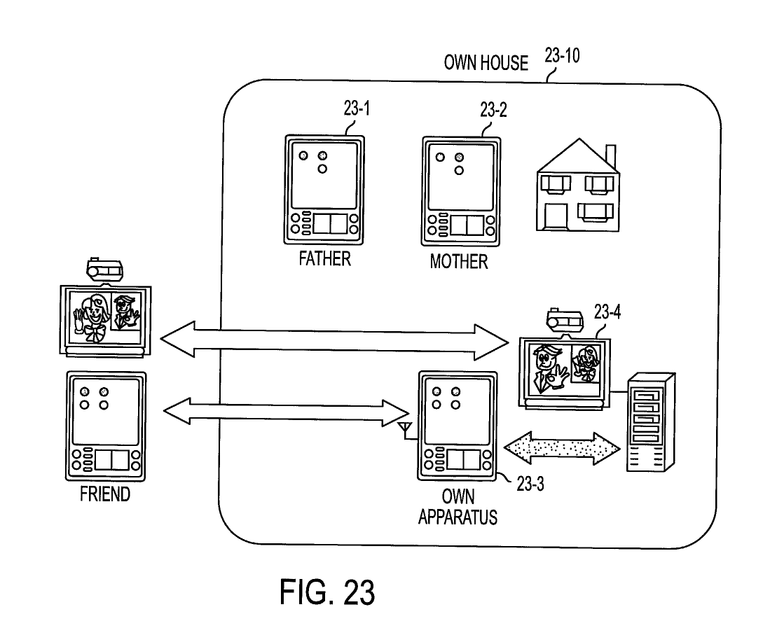

FIG. 23 illustrates an example of the use of the hand-held terminal and server of the present invention in the user's house. As illustrated in this figure, the multimedia communication apparatus such as the video communication apparatus 23-4 installed in the user's house may be used in common with the hand-held terminals 23-1, 23-1, 23-3 of all family members. When the hand-held terminals 23-1, 23-2, 23-3 use the video communication apparatus 23-4, reservation control is performed using each terminal identification information with the dynamic negotiation function in order to prevent competitive use of the video communication apparatus 23-4 among a plurality of hand-held terminals 23-1, 23-2, 23-3. Moreover, it is possible to make multimedia communication using the line of lower communication charge and thereby total communication charge of the household as a whole can be saved.

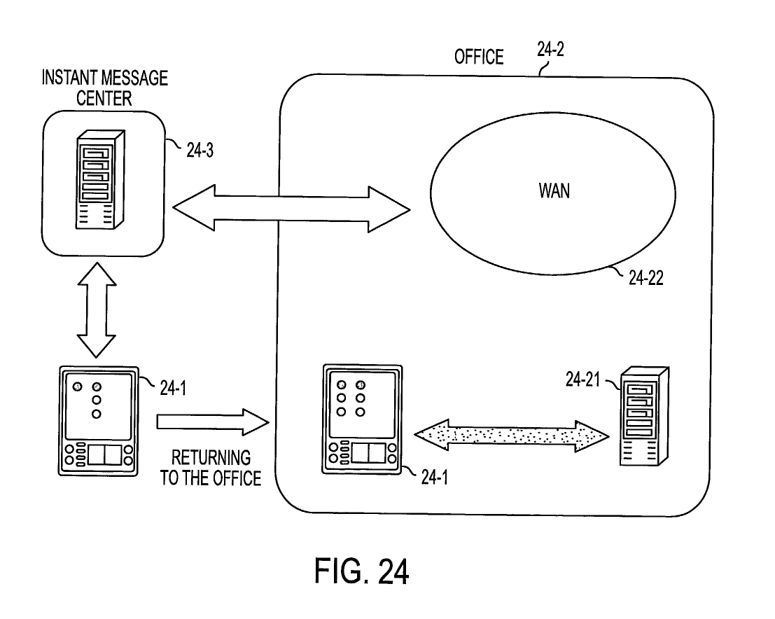

FIG. 24 illustrates an example of use of the hand-held terminal and server of the present invention in the working office or the like. A user connects the hand-held terminal 24-1 to an instant message center 24-3. When a user returns to the working office 24-2 from the outside under the condition that the personal information of the user (for example, schedule, instruction, report or the like) is used in common within a certain project team, the communication path is changed to the local WAN (Wide Area Network) in the company via the multimedia home server 24-21 installed in the office with the automatic line selection function of the hand-held terminal 24-1 and thereby the communication charge can be lowered. Moreover, the instant message utilizing the radio communication at the outside of company can also be used easily through the seamless message hand-over between the office and outside of the company.

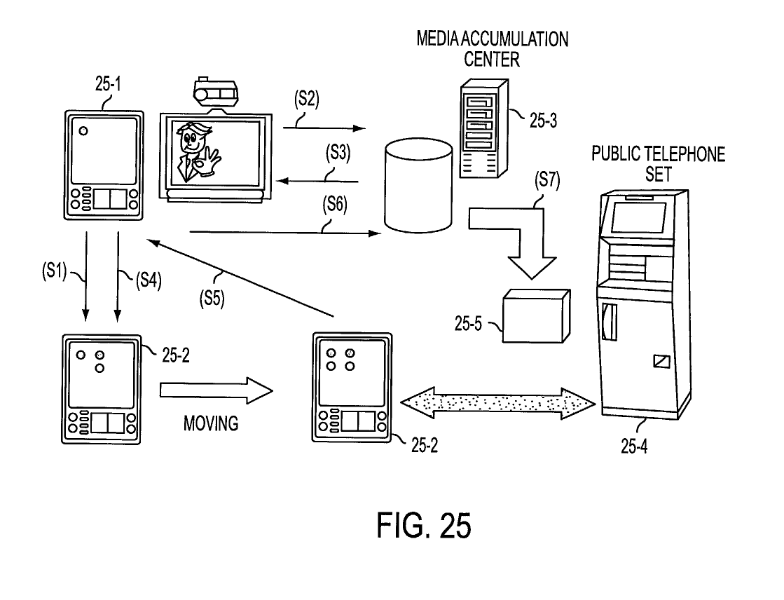

FIG. 25 illustrates an example of use of the hand-held terminal of the present invention in the public telephone set. When a user is requested to receive a large capacity of data such as video data from the communication apparatus 25-1 of the communication partner, the user carrying the hand-held terminal 25-2 can receive the large capacity data from the communication partner in the following procedure using the nearest public telephone set (including a large capacity data writer) 25-4.

First, the communication apparatus 25-1 of the communication partner notifies of a transfer of a large capacity of data to a user of the hand-held terminal 25-2 (step S1). The communication apparatus 25-1 of the communication partner having received this notification transfers the large capacity data to the media accumulation center 25-3 (step S2). After the transfer of the large capacity of data, the media accumulation center 25-3 notifies the end of reception of the large capacity of data to the communication apparatus 25-1 (step S3).

Upon reception of a message notifying the end of reception of the large capacity of data, the communication apparatus of the communication partner 25-1 notifies, to the hand-held terminal 25-2, transmission of the large capacity of data to the media accumulation center 25-3 (step S4). The hand-held terminal 25-2 having received the message displays this message. Here, a user goes to the nearest public telephone set 25-4, connects its own terminal through the local radio connection. Then the profile information of the public telephone set 25-4 is notified to communication apparatus 25-1 of the communication partner (step S5).

The communication apparatus of the communication partner 25-1 notifies the profile information of the public telephone set 25-4 to the media accumulation center 25-3 (step S6) and the media accumulation center 25-3 starts transfer of the large capacity of data to the public telephone set 25-4 (step S7). Any one of a part of the large capacity of data, whole large capacity of data, the title of the large capacity of data and the time which the public telephone set 25-4 received the large capacity of data is transmitted to the hand-held terminal 25-2. The media accumulation medium 25-5 of the hand-held terminal 25-2 stores received data from the public telephone set 25-4. It is also possible to output the data from a printer connected to the public telephone set 25-4.

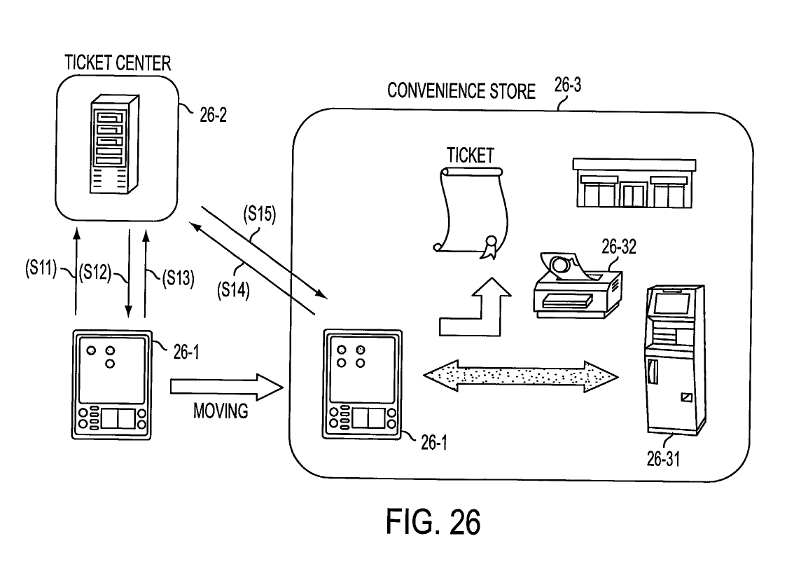

FIG. 26 illustrates an example of use of the hand-held terminal of the present invention in a convenience store. In this example, it is now possible to get a ticket for an event in a convenience store in an area near the place where an event is held without waiting for cancellation of ticket at the ticket center.

A user notifies to the ticket center 26-2 that the user is waiting for cancellation of the ticket by transmitting canceled ticket reservation request signal including the information of the identification information of the hand-held terminal 26-1 from the hand-held terminal 26-1 (step S11). The ticket center 26-2 notifies generation of cancellation to the hand-held terminal 26-1 by transmitting cancellation generation announce signal to the hand-held terminal when a cancellation of event ticket is generated (step S12).

The user of hand-held terminal 26-1 notifies tentative reservation of the ticket cancelled to the ticket center 26-2 (step S13) by transmitting the tentative reservation signal to the ticket center 26-2. And the hand-held terminal 26-1 connects to the multimedia home server 26-31 at the nearest convenience store 26-3 and occupies the printer 26-32 controlled by the multimedia home server 26-31. Thereafter, the hand-held terminal transmits the multimedia profile information including the reservation of the printing function of the printer to the ticket center 26-2 (step S14).

The ticket center 26-2 subtracts, in turn, the ticket charge from the electronic money of the user authentication card of the hand-held terminal 26-1 and transmits the ticket content information to the hand-held terminal 26-1 (step S15). The hand-held terminal 26-1 transmits the ticket content to the reserved printer 26-32 at the convenience store 26-3. The reserved printer 26-32 prints the ticket paper. The user of the hand-held terminal 26-1 can get the ticket paper in the convenience store.

Since a ticket receiving person is waiting for the printing at the time of printing the ticket, the staff of store can save the procedures for checking the ticket receiving person. In addition, since the printer application charge and ticket charge are automatically collected from the user authentication card, the staff of the convenience store is released from such charge collecting procedures.

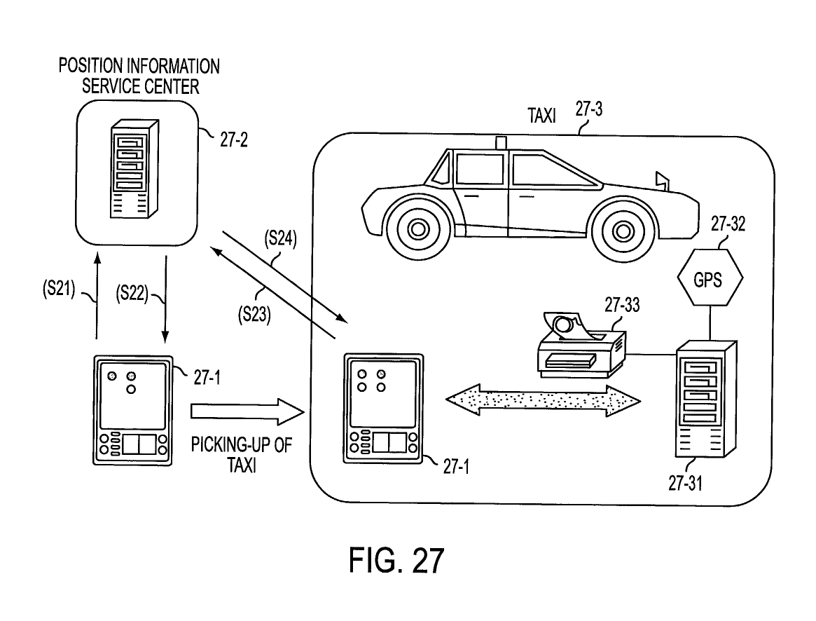

FIG. 27 illustrates an example of the use of the hand-held terminal of the present invention when the user is in a taxi. The multimedia communication function of the hand-held terminal and a position information apparatus (for example GPS apparatus) of the taxi are interlocked for mutual operation as explained below. Thereby, the time required to move to the destination can be shortened and position information service with the wireless position measurement before taking the taxi and after leaving the taxi may be used continuously.

Before the user of the hand-held terminal 27-1 gets into the taxi, the user manipulates its own terminal to transmit the request navigation to the position information service center 27-2 (step S21). Namely the hand held terminal transmits the navigation request signal including the destination information of the user to the position information service center 27-2.

When the user of the hand-held terminal 27-1 picks up a taxi and gets into the taxi, the hand-held terminal is connected to the multimedia home server 27-31 in the taxi and the hand-held terminal occupies the GPS system 27-32 and printer 27-33. Hereafter the user of the hand-held terminal manipulates the hand-held terminal to transmit the request to the position information service center 27-2 for the map information indicating the route from here (the position information of the taxi measured by the GPS system 27-32 is transmitted to the position information service center 27-2) to the destination (already transmitted to the position information service center 27-2).

Then the position information service center transmits the map information including the route together with the peripheral shop information to the printer 27-33 and the printer prints out the map.

In the above embodiments, the multimedia communication apparatus is used through a connection with a server (multimedia home server), but it is also possible, in place of providing a server apparatus independent of the multimedia communication apparatus, to provide, to the multimedia communication apparatus itself, the management function (profile management function) for management of usability and reservation condition of the negotiation function for the hand-held terminal and various multimedia communication functions. In the case where the server is used, excellent management efficiency can be attained because integrated management can be realized without provision of the relevant management function to all of the multimedia communication apparatuses.

As explained above, according to the present invention, various multimedia communication services such as IMT2000 mobile system or the like can be utilized using the hand-held terminal of the simplified structure and moreover the hand-held terminal has realized reduction in size, weight and cost by making it possible for both server connected to the multimedia communication service apparatus and the hand-held terminal to use each service function through individual occupation by the hand-held terminal.

Moreover, the various multimedia communication service apparatuses connected to the sever may be used in common with a plurality of hand-held terminals in order to have effective use of various multimedia communication service apparatuses, and thereby it is also possible to easily take a measure for addition of function and improvement of performance of various multimedia communication service. As a result, the multimedia communication service having a higher degree of freedom can be offered and accelerated in use.

What is claimed is:

1. A hand-held terminal for multimedia communication, comprising:
a means for negotiating with a server controlling a multimedia communication apparatus for reserving a function of said multimedia communication apparatus; and
a means for conducting multimedia communication with a communication apparatus of a communication partner through a negotiation with the communication apparatus of the communication partner in regard to said function that is reserved with said negotiation.

2. The hand-held terminal of claim 1, further comprising:
a means for displaying the multimedia communication function reserved by said hand-held terminal.

3. The hand-held terminal of claim 2, wherein said means for displaying the multimedia communication function further displays a function of the communication apparatus of the communication partner, wherein said function is notified through the negotiation with the communication apparatus of the communication partner.

4. The hand-held terminal of claim 2, wherein said means for displaying displays a selectable condition, the reserved condition and a using condition of the multimedia communication.

5. The hand-held terminal of claim 1, further comprising:
a unit for storing, to an information storage medium being connectable to the server, information for cryptographic communication to encrypt local communication between the hand-held terminal and the server.

6. The hand-held terminal of claim 1, further comprising:
a selector for selecting a communication link, depending on the manipulation of a user of the hand-held terminal or the preset logic, from a plurality of communication links to be used for multimedia communication with the communication apparatus of the communication partner and ensuring such communication link for the multimedia communication using the function.

7. A server, comprising:
a unit for managing a multimedia communication apparatus;
a unit for conducting negotiation with a hand-held terminal for reservation of a function of the multimedia communication apparatus; and
a unit for reserving the function for the hand-held terminal.

8. A hand-held terminal for conducting a multimedia communication between itself and a partner communication terminal, comprising:
a transmitting unit to transmit signals to the partner communication terminal;
a and controlling unit to control said transmitting unit to transmit information with respect to a class of multimedia communication being available for itself to the partner communication terminal.

9. A hand-held terminal for conducting a multimedia communication between itself and a partner communication terminal, comprising:
a transmitting unit to transmit signals to the partner communication terminal; and
a controlling unit to control said transmitting unit to transmit information with respect to a class of multimedia communication, at the time of starting the communication, being available for its own terminal.

10. A hand-held terminal for conducting a multimedia communication between itself and a partner communication terminal, comprising:
a transmitting unit to transmit signals to the partner communication terminal; and
a controlling unit to control said transmitting unit to transmit information with respect to a class of multimedia communication, during the communication with the partner communication terminal, being available for its own terminal.

11. A hand-held terminal for conducting a multimedia communication between itself and a partner communication terminal, comprising:
a transmitting unit to transmit signals to the partner communication terminal; and
a controlling unit to detect a change of a class of multimedia communication available for its own terminal during a communication with the partner communication terminal and then control said transmitting unit to transmit information with respect to the change of the class of multimedia communication.

12. A hand-held terminal for conducting a multimedia communication between itself and a partner communication terminal, comprising:
a transmitting unit to transmit signals including information with respect to a class of multimedia communication services available to itself to the partner communication terminal,
a receiving unit to receive signals including information with respect to a class of multimedia communication services available to the partner communication terminal from the partner communication terminal,
a display unit, and
a controlling unit to control said display unit to display information of a class of multimedia communication services available for use between itself and the partner communication terminal using the information received by said receiving unit.

13. A hand-held terminal for conducting a multimedia communication between itself and a partner communication terminal, comprising:
a communication unit to negotiate with at least one of a multimedia communication apparatus and a server controlling said multimedia communication apparatus for reservation of a function of said multimedia communication apparatus during the multimedia communication with the partner communication terminal,
a transmitting unit to transmit signals to the partner communication terminal, and
a controlling unit to detect a change of a class of multimedia communication available for own terminal through the negotiation and then control said transmitting unit to transmit signals including information with respect to the change of the class of multimedia communication.

14. As system providing multimedia communication for a hand-held terminal, comprising:
a server for managing a multimedia communication apparatus, and having a negotiation unit for negotiating with said hand-held terminal for reservation of a function of the multimedia communication apparatus, and for reserving the function for the hand-held terminal after negotiation, and
a controller in said hand-held terminal for negotiating with said server for reserving a function of said multimedia communication apparatus, and for conducting multimedia communication with a communication apparatus of a communication partner through a negotiation with the communication apparatus of the communication partner.

15. A mobile terminal for multimedia communication, comprising:
a mobile radio communication unit providing an interface to a mobile radio communication network,
a local radio communication unit for providing an interface to a local area radio communication network, and
a controller unit to control said mobile radio communication unit and to negotiate with other communication apparatus for reserving multimedia services, and
a display unit to display a status of multimedia services.

16. The mobile terminal of claim 15, wherein said controller unit, further comprising:
a profile information management unit for managing profile information of said mobile terminal,
a remote controller control unit for controlling peripheral apparatus including said display unit, and
a local communication security unit for providing security features for said local radio communication unit when communicating with said local area radio communication network.
